(19) United States
(12) Patent Application Publication
(10) Pub. No.: US 2007/0026955 A1
(43) Pub. Date: Feb. 1, 2007

(54) INERTIA RING FOR SUPPRESSION OF DRIVESHAFT RADIATED NOISE

(75) Inventors: Mark Bosca, St. Clair Shores, MI (US); Chris Kwasniewicz, Novi, MI (US); Robert Bruce Bonhard, Milford, MI (US); Takeshi Abe, Garden City, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 11/536,807

(22) Filed: Sep. 29, 2006

Related U.S. Application Data
(63) Continuation-in-part of application No. 10/709,284, filed on Apr. 27, 2004.

(51) Int. Cl. F16C 3/00

(52) U.S. Cl. 464/180

(57) ABSTRACT

A combination of an inertial body and a shaft including an elongated hollow member having a vibration characteristic that includes a bending mode and a breathing mode, the bending mode vibration characteristic and the breathing mode vibration characteristic having closely coupled resonance frequencies. An inertial body is attached to the elongated hollow member in the proximity of a bending mode vibration antinode to decouple the bending mode resonance frequency from the breathing mode resonance frequency.

### CROSS-REFERENCE TO RELATED APPLICATIONS

This application is a continuation-in-part of U.S. application Ser. No. 10/709,284 filed Apr. 27, 2004.

### BACKGROUND OF THE INVENTION

1. Field of the Invention

The present invention relates to a driveshaft assembly that includes an inertia ring for reducing the noise emitted by the driveshaft due to vibrations in the drivetrain.

2. Background Art

Torque transmitting devices are used to transfer rotational power from one source to a rotatably driven mechanism. One example of a torque transmitting shaft is a driveshaft used in a powertrain of an automobile. The driveshaft transfers the rotational power from the engine of the automobile to a driven component such as the rear axle. Typically, a vehicle's driveshaft assembly includes a hollow cylindrical shaft having an end fitting secured to each end. One fitting is generally connected to the transmission while the other fitting is connected to the rear axle.

One problem encountered with driveshaft assemblies is that they tend to transmit undesirable noises during operation. All mechanical bodies have resonant frequencies that may cause objectionable noise levels when operated at certain rotational speeds. Resonant frequencies may vary based on factors such as the composition, size and shape of the object. One objective of vehicle design is to reduce the noise caused by the vibration of the driveshaft and provide a quieter ride.

Many different mechanisms have been proposed to dissipate or absorb the vibrations emitted by the automobile's driveshaft during operation. Some of these mechanisms include torsional tuned absorbers, cardboard liners, foam liners, damping sleeves and internally tuned absorbers. Torsional tuned absorbers dissipate energy at a specified frequency by oscillating a mass but are limited to lower frequency applications (e.g. vibrations that are less than 600 Hz). Cardboard liners dissipate energy through frictional losses but are subject to substantial variation in effectiveness due to factors such as fit, humidity at the time of assembly, and their installation location. Foam liners are also of limited use due to variability caused by fit. Damping sleeves function to shift the driveshaft resonance peaks to regions of lower external excitation energy but do not reduce overall noise and vibration of the shaft. For example, a damping sleeve may be used to shift a drivetrain vibration peak resonance away from a vehicle resonant vibration.

Some of the above prior art noise reduction structures may be assembled into the hollow center of the driveshaft while others may be assembled to the outer surface of the driveshaft. Such noise reduction structures can be difficult to install as a retrofit or in a service operation by a mechanic. Additionally, several of these solutions simply dampen or muffle the noise and vibration rather than preventing or avoiding the conditions which cause the noise and vibration.

One source of drive shaft noise and vibration is the close coupling of the drive shaft's breathing mode vibrational resonance and bending mode vibrational resonance. Reference to breathing mode vibrations of the drive shaft refers to the radial expansion and contraction of the shaft. Reference to bending mode vibrations of the drive shaft refers to the spacial displacement in a plane of the drive shaft from its central axis. The breathing mode and bending mode vibrations of the shaft can be triggered by high frequency gear transmitted gear conjugation error emanating from the transmission or axial gears. Gear conjugation error is an error in force transmission due to angular misalignment of gears as they engage. When the gears do not engage smoothly, vibration can be transmitted to the drive shaft. This vibration can excite the drive shaft bending mode and breathing mode vibrations.

As the engine speed increases, the frequency of the gear conjugation error correspondingly increases. As the gear conjugation error frequency increases, the amplitude of bending mode vibration antinodes and the amplitude of breathing mode vibration antinodes increase until the drive shaft is in bending mode or breathing mode vibrational resonance (i.e. the point at which the amplitude of the antinode is the greatest for a particular mode shape). As the gear conjugation error frequency increases beyond the respective resonance frequencies for the bending mode vibrations and the breathing mode vibrations, the amplitude of the bending mode vibration antinode and the amplitude of the breathing mode vibration antinode diminish until they are at, or near, zero. As the gear conjugation error frequency increases further, the shape of the vibration mode (bending or breathing) advances to the next mode (i.e., from a first bending mode shape to a second bending mode shape) and the amplitude of the bending mode vibration antinode and the amplitude of the breathing mode vibration antinode once again begin to increase until they reach their respective points of resonance, after which their amplitudes diminish and approach zero. This cycle repeats itself as long as the gear conjugation error frequency continues to increase.

The resonance frequencies for the drive shaft's bending mode vibrations are generally not the same as the resonance frequencies for the drive shaft's breathing mode vibrations. Rather, the drive shaft is rarely in bending mode vibrational resonance at the same time that the drive shaft is in breathing mode vibrational resonance. When the respective bending and breathing mode vibrational resonances occur at, or near, the same frequencies, the bending mode vibration antinodes coincide with the breathing mode vibration antinodes. The consequence of this phenomenon is that the bending mode and breathing mode vibrations will amplify one another. At this frequency, the noise and vibration transmitted by the drive shaft is most severe. The simultaneous or near simultaneous occurrence of bending mode and breathing mode vibrational resonance is referred to as being “closely coupled.” As used herein, the term “closely coupled” refers to the condition where the drive shaft bending mode vibrational resonance occurs at a frequency that is within 5% of the frequency at which the drive shaft is in breathing mode vibrational resonance, and vice versa.

The prior art solutions to drive shaft noise and vibration do not address the problem of closely coupled bending mode and breathing mode resonance frequencies. This and other problems are addressed by the applicant's invention, as summarized below.

### SUMMARY OF THE INVENTION

One aspect of this invention relates to a combination of an inertial body and a shaft. In one embodiment, an elongated hollow member having a vibration characteristic that includes a bending mode and a breathing mode is provided. The bending mode vibration characteristic and the breathing mode vibration characteristic of the elongated hollow member have closely coupled resonance frequencies. A inertia member of predetermined mass is also provided. The inertia member is attached to the elongated hollow member in close proximity to a bending mode vibration antinode to decouple the bending mode resonance frequency from the breathing mode resonance frequency. In at least one embodiment, the elongated hollow member may be a drive shaft. In at least another embodiment, high frequency gear transmitted errors from either a transmission or an axle cause an expansion and contraction of the elongated hollow member in the breathing mode. In at least another embodiment, high frequency gear transmitted errors from either a transmission or an axle cause an oscillation of the elongated hollow member in the bending mode. In at least one embodiment, the inertia member may be attached to the elongated hollow member in proximity to a bending mode vibration antinode nearest an end of the elongated hollow member. In at least another embodiment, the inertia member may be fixed to the elongated hollow member using a press fit. In at least another embodiment, the inertia member includes two separate halves. In such embodiments, the inertia member may be affixed to the elongated hollow member by clamping the two halves to the elongated hollow member.

Another aspect of the present invention relates to a drive shaft for torque transmission purposes especially for use in a drive train of a motor vehicle. In one embodiment, a shaft having first and second ends and a central region is provided. An inertia ring is also provided. The inertia ring is fixed at a bending mode antinode on the shaft such that the inertia ring decouples a closely coupled bending mode vibrational resonance frequency from a breathing mode vibrational resonance frequency to reduce the amplitude of shaft vibrations. This in turn can reduce the amount of noise emitted by the drive shaft.

In at least another embodiment, the inertia ring is fixed to the shaft at a bending mode antinode nearest a rear axle. In at least another embodiment, the inertia ring has an inner diameter and the shaft has an outer diameter wherein the outer diameter of the shaft is greater than the inner diameter of the inertia ring so that the inertia ring may be pressed fit onto the shaft. In another embodiment, the inertia ring is securely fixed to the shaft and does not oscillate or vibrate independently from the shaft. In at least another embodiment, the inertia ring is rotationally symmetrical. In at least another embodiment, the weight of the inertia ring is determined by finite element analysis of the drive train. In at least another embodiment, the inertia ring can be made of aluminum. In at least another embodiment, the inertia ring can be made of steel. In at least another embodiment, the weight of the inertia ring can be determined by testing.

In another aspect of the present invention, a drive train for a vehicle having an engine, transmission, differential and drive shaft connection is disclosed wherein the drive shaft connection includes a shaft having a first and second ends and a central region, and an inertia ring having an inner opening fixed at a specified point on the shaft. The inertia ring can decouple the frequency at which bending mode vibrational resonance occurs from the frequency at which breathing mode vibrational resonance occurs. Such decoupling can reduce the amplitude of drive shaft vibrations and limit the amount of noise emitted by the drive shaft.

In at least one embodiment, the inertia ring is fixed at an antinode. In at least another embodiment, an outer diameter of the shaft is greater than inner diameter of the inertia ring so that the inertia ring may be pressed fit in place at a desired location corresponding to an antinode. In at least another embodiment, the inertia ring is centrally fixed to the shaft such that it does not oscillate or vibrate independently from the drive shaft.

These and other aspects of the invention will be better understood in view of the attached drawings and the following detailed description of the preferred embodiments.

### BRIEF DESCRIPTION OF THE DRAWINGS

FIG. 1 shows an engine and a driveshaft of a rear wheel drive motor vehicle;

FIG. 2 is a longitudinal section through a first embodiment of the driveshaft with an inertia ring attached;

FIG. 3 shows a section through line 3—3 of FIG. 2 where the inertia ring is installed using a press fit;

FIG. 4 shows an exaggerated section through line 4—4 of FIG. 2 where the inertia ring is installed using a press fit;

FIG. 5 shows a section similar to FIG. 3 but illustrating an inertia ring that is manufactured in two separate halves and installed by clamping the two halves together;

FIG. 6 is an exaggerated perspective view of a drivetrain without an inertia ring experiencing closely coupled bending mode vibrational resonance and breathing mode vibrational resonance;

FIG. 7 is an exaggerated side view of the drivetrain of FIG. 6 with an inertia ring attached as it experiences bending mode vibrational resonance that has been decoupled from breathing mode vibrational resonance;

FIG. 8 is an exaggerated perspective view of the drivetrain of FIG. 6 with an inertia ring attached experiencing breathing mode vibrational resonance that has been decoupled from bending mode vibrational resonance;

FIG. 9 is a graph demonstrating the different sound emitted by the rotation and vibration of a driveshaft at a given frequency comparing a driveshaft without an inertia ring to a driveshaft with an inertia ring of specified weight attached.

### DETAILED DESCRIPTION OF THE PREFERRED EMBODIMENT(S)

One solution to the problems set forth above is to securely fasten a inertia member or inertia ring to the elongated hollow member or drive shaft. The inertia ring is preferably positioned along the drive shaft at a bending mode vibration antinode for a bending mode shape corresponding to the frequency at which the bending mode vibrational resonance is closely coupled with the breathing mode vibrational resonance. Preferably, the inertia ring will be positioned at the antinode nearest the end of the driveshaft for the particular frequency of concern. Most preferably, the inertia ring will be positioned at the antinode nearest the rear axle.

The bending mode vibrations and the breathing mode vibrations of the drive shaft are determined by the physical properties of the drive shaft such as the drive shaft's length, mass, dimensions, and material. Placing the inertia ring on the drive shaft alters the physical characteristics of the drive shaft. One consequence of this alteration is that the inertia ring separates the frequency at which the drive shaft is in bending mode vibrational resonance from the frequency at which the drive shaft is in and breathing mode vibrational resonance. Thus, the inertia ring “decouples” the bending mode and breathing mode vibrational resonance frequencies. As used in this application, the term “decouple”, and variations thereof, means that the respective resonance frequencies for the bending mode vibrations and the breathing mode vibrations are separated by at least 10 percent. Decoupling the bending mode vibrational resonance frequency from the breathing mode vibrational resonance frequency inhibits the ability of the bending mode antinode and the breathing mode antinode to amplify one another, which in turn, diminishes vibration and noise. If the bending mode vibrational resonance frequency and the breathing mode vibrational resonance frequency can be separated by 15% or more, the bending and breathing mode vibrations will have no amplifying effect on one another. Installation of the inertia ring is quick and easy and may be more cost effective and efficient than current designs.

Finite element analysis can be used to determine both the bending and breathing modes of a driveshaft. A commercially available FEA software program, for example “Nastran®”, a registered trademark of the National Aeronautics and Space Administration, can be used to perform the FEA modeling. Using the FEA software, a natural mode shape is generated where the bending and breathing modes can be observed.

The first antinode can be readily observed using FEA by observing an animated display of the natural mode of the frequency of interest. When a driveshaft design is determined to produce undesirable radiated noise, the driveshaft is rotated through a range of frequencies until the maximum level of undesirable sound is detected. The frequency of interest is defined as the frequency of the maximum undesirable sound.

The weight of the inertia ring is determined by adjusting the weight in the finite element model and monitoring the radiated sound emanating from the drive shaft. The mass of the inertia ring is iteratively adjusted until the radiated sound is below the radiated sound target. Generally, the mass of the inertia ring is the minimum amount of mass that can achieve the radiated sound target.

The radiated sound can be measured by suspending a microphone 1 meter above the drive shaft or by requesting the sound level one meter away from the driveshaft in the FEA model. The radiated sound target can be provided by vehicle development teams based upon their knowledge of customer satisfaction.

Vibrational resonances within 15% of one another will tend to start to couple or interact with each other. Vibrational modes that lie within 5% of each other are closely coupled and begin to have significant interaction.

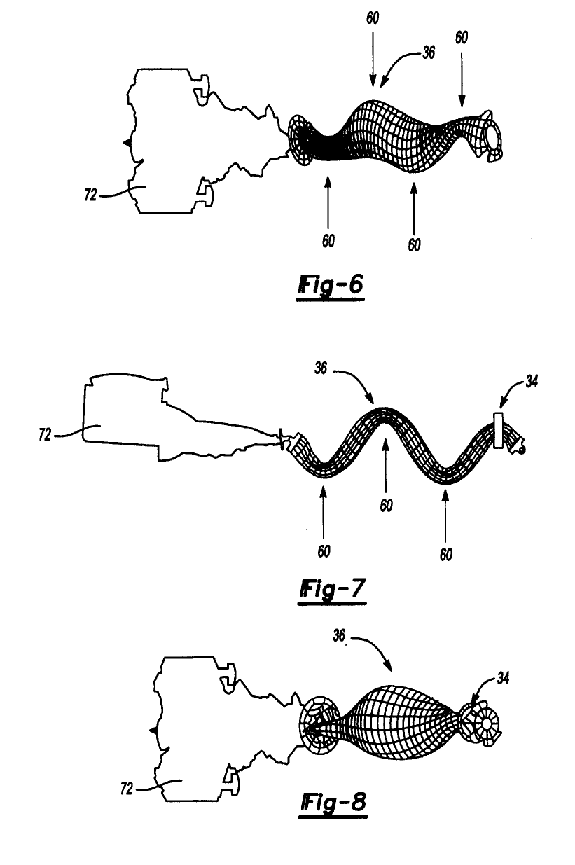

Below is a step by step process for determining the location and mass of the inertia ring to reduce driveshaft radiated sound:
Step 1. Assemble FEA vibration models of engine, transmission, driveshaft.
Step 2. Run a normal modes analysis to determine the natural mode shapes of the system, particularly the driveshaft, using a finite element analysis software program, such as Nastran®.
Step 3. To suppress driveshaft radiated sound due to transmission whine, normal modes in the 1000 to 1250 Hz range are analyzed that show the bending and breathing mode vibrational resonances are coupled. (Note this frequency range has been determined by vehicle testing to be a problem for customer noise levels.) A good example of a driveshaft having closely coupled bending and breathing mode vibrational resonance is illustrated in FIG. 6.
Step 4. Starting from the rear U-joint center line of the driveshaft move forward on the driveshaft toward the engine until the location of first local maximum displacement is determined. This is called the first anti-node from the driveshaft rear U-joint. This distance is recorded so that it can be provided to manufacturing for inertia ring placement.
Step 5. A frequency dependent displacement is applied at the end of the transmission that simulates the excitation displacement from the transmission. This displacement is obtained from testing that is conducted by placing accelerometers on the end of the transmission and recording the acceleration. This acceleration value is double integrated to provide a displacement value.
Step 6. The sound radiated from the driveshaft is monitored as a function of frequency by using commercial sound analysis codes such as Sysnoise®, which is a registered trademark of Numerical Integration Technologies, or Comet Acoustics®, which is a registered trademark of Automated Analysis Corporation. This provides a sound response curve as the top curve in FIG. 8.
Step 7. At the location determined in step 4, an inertia ring is assembled around the outside of the driveshaft that is 1 inch wide and ¼″ tall. The dimensions of the inertia ring are somewhat arbitrary, but are selected as a starting point. If conducting the analysis on a steel driveshaft, the inertia ring is made to simulate an inertia ring having the material properties of steel. If the driveshaft is made of aluminum, the inertia ring is made to simulate the material properties of aluminum. This is done to minimize any potential loosening of the ring when the production part is made due to thermal expansion of dissimilar materials.
Step 8. Repeat step 5 and 6 generating a new sound response curve which should be somewhat lower that the sound response curve generated in step 6.
Step 9. The goal is to provide a 20 dB drop in sound levels from the peak amplitude in the frequency range of 1050 to 1200. It is then determined whether the new sound level obtained in step 8 meets the 20 dB reduction target.
Step 10. If the 20 dB reduction target is not met, the diameter of the inertia ring may be increased by 10%. Step 5 and 6 are repeated to determine if target is met.
Step 11. If target is not met in step 10, repeat step 10 until target is met. The 10% increments are arbitrary and other increments may be used.
Step 12. After step 10 has been repeated sufficiently such that the target is met, the analysis may be stopped and the mass and inertia of the ring are recorded. This information is provided to manufacturing as the specification for the inertia ring.

Alternatively, the location of the first antinode and the weight of the inertia ring can be determined through testing. The following procedure is one way of making these determinations:

1. On a powertrain dynamometer rig assemble an engine, transmission, driveshaft and rear axle.

2. Above the driveshaft assemble an array of microphones in line with the driveshaft roughly 2″ apart and 6″ above the surface of the driveshaft.

3. Run the engine through the driving range tracking the gear mesh ratio in the particular gear of interest which exhibits the gear whine. The same procedure could be used to track the rear axle mesh order.

4. Record the sound from the microphones and, tracking the order of gear meshing, determine the first sound peak in the driveshaft closest to the rear axle. This is the first antinode and where the inertia ring should be placed.

5. Start with a small ring and measure the sound reduction by averaging the sound signal from the array of microphones.

6. If the reduction does not meet 20 dB target, increase the weight of the ring and repeat the test. Continue this process until 20 dB is obtained.

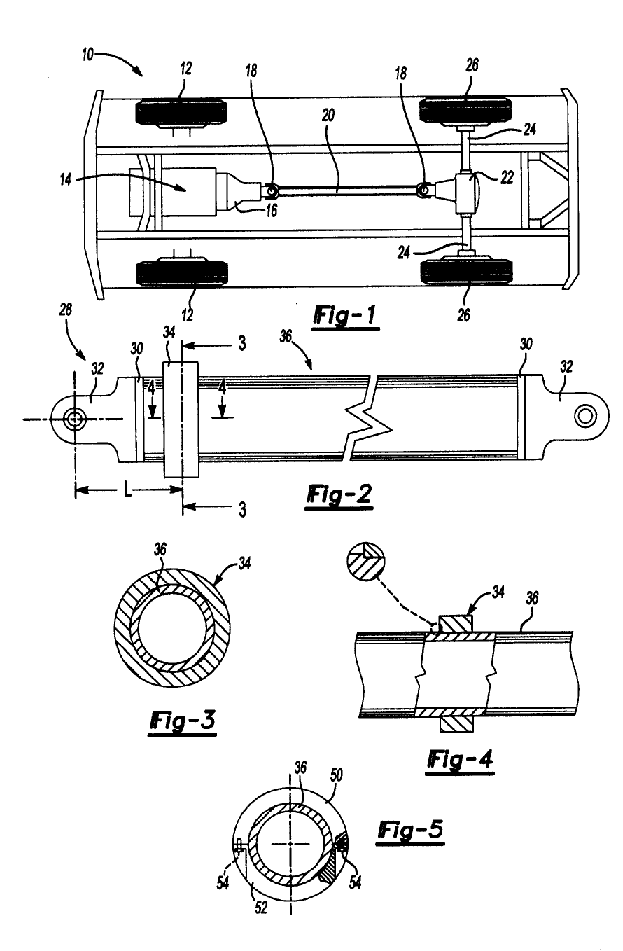

FIG. 1 is a diagram of a rear wheel drive motor vehicle 10 having a pair of front wheels 12 and an engine 14 that is located between the front wheels 12. While the illustrated embodiment is of a rear wheel drive vehicle the invention can also be applied to front wheel drive vehicles and other types of driveshafts. The engine 14 provides power to a longitudinally extending driveshaft 20 through a gear box 16. The gear box 16 is attached to a universal joint 18. The driving torque for the rear wheels 26 is transmitted from the gear box 16 through the longitudinal driveshaft 20. The driveshaft 20 has a first end 20a, a second end 20b and a central region 20c. The driveshaft 20 supplies the driving torque to the rear axle differential 22. The rear axle differential 22 provides power to the rear wheels 26 through a pair of rear axle half shafts 24.

A rotating driveshaft 20 having a closely coupled bending and breathing mode is undesirable and may be made unintentionally when the driveshaft 20 is designed without analyzing the bending and breathing modes.

A closely coupled bending and breathing mode occurs in, but is not limited to, an exemplary shaft of aluminum tubing 2.21 mm thick, 1925.4 mm long and an outside diameter of 114.3 mm. This coupling occurs at 1071 Hz. Another example would be an aluminum tube 2.21 mm thick, 1808.5 mm long and an outside diameter of 100 mm. This coupling occurs at 1130 Hz.

FIG. 2 shows a driveshaft assembly 28 with a tube yoke 32 attached to an end fitting 30 that is disposed within each end of the driveshaft 36. The tube yoke 32 is welded to the driveshaft 36. An inertia ring 34 is either press fit or clamped to the driveshaft 36. The inertia ring 34 is placed at a distance L from the end of the driveshaft assembly 28 which corresponds to the location of an antinode that is nearest the end of the driveshaft 36.

FIG. 3 shows a section taken along the line 3—3 of FIG. 2 showing the inertia ring 34 press fit to the driveshaft 36. FIG. 4 shows an exaggerated section along connecting line 4—4 of FIG. 2 that is exaggerated to demonstrate how the inertia ring 34 is press fit onto the driveshaft 36. The diameter of the driveshaft 36 is compressed to a slightly smaller diameter because the inertia ring 34 has an inner diameter that is slightly smaller than the outer diameter of the driveshaft 36.

FIG. 5 shows a section similar to the section taken along the line 3—3 of FIG. 2 through the inertia ring 34 that is clamped onto the driveshaft 36. The clamping arrangement connecting the top half 50 of the inertia ring 34 to the bottom half 52 of the inertia ring 34 may be provided by means of a pair of fasteners 54.

FIGS. 6-8 are drawings showing the decoupling of the breathing mode vibrational resonance from the bending mode vibrational resonance of driveshaft 36. FIG. 6 shows driveshaft 36 as it experiences closely coupled breathing mode and bending mode vibrational resonance, with the breathing and bending modes being depicted in an exaggerated fashion. In FIG. 6, the driveshaft 36 lacks the inertia ring 34. FIGS. 7 and 8 show the driveshaft 36 with the inertia ring 34 attached and the bending and breathing mode vibrational resonances decoupled. FIG. 7 shows the driveshaft 36 as it experiences bending mode vibrational resonance (exaggerated). FIG. 8 shows the driveshaft 36 as it experiences breathing mode vibrational resonance (exaggerated).

With reference to FIG. 6, a plurality of anti-nodes 60 of the coupled bending and breathing mode vibrations are clearly visible. In the embodiment illustrated in FIG. 6, the inertial body (also referred to as an inertia ring) will be fixed at the antinode furthest from the transmission 72 so as not to appreciably reduce the first mode bending frequency which can lead to noise, vibration and harshness issues.

As shown in FIGS. 7 and 8, the inertia ring 34 is securely fixed to the driveshaft 36 and does not oscillate or vibrate independently from the driveshaft 36. The inertia ring 34 is rotationally symmetrical. The inertia ring 34 may be made of aluminum or steel. The weight of the inertia ring can be determined by testing or finite element analysis. The inertia ring is securely fixed to the driveshaft and does not oscillate or vibrate independently from the driveshaft.

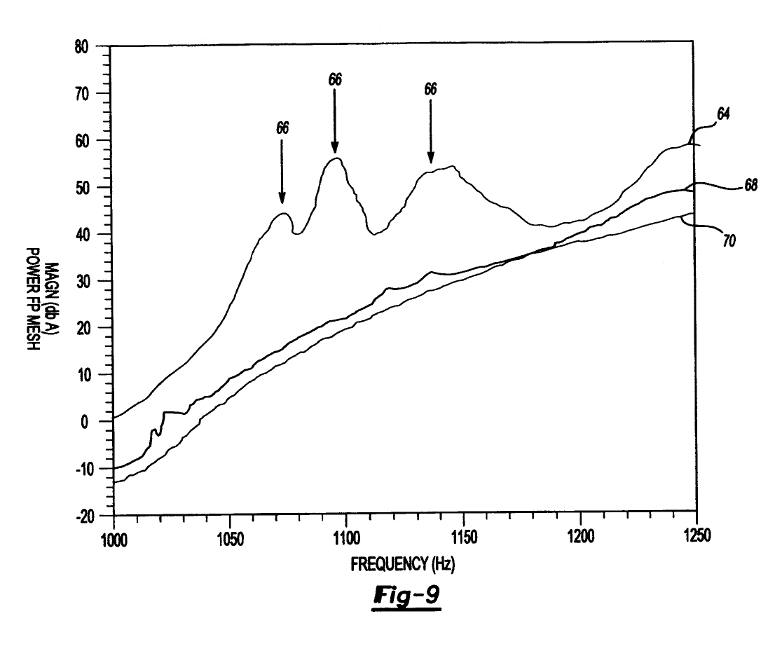

FIG. 9 is a graph comparing the different sound levels created by the rotation and vibration of a sample driveshaft 36 at a given frequency. This graph compares an unmodified response 64 which has no inertia ring 34 to driveshafts 36 with either a two pound inertia ring 34 illustrated as response 68 or 9.4 pound inertia ring 34 illustrated as response 70. When either inertia ring 34 is attached there is a substantial reduction in the sound emitted by the driveshaft 36. Both inertia rings 34 create an operating environment where the sound emitted increases gradually as the frequency increases. The use of either inertia ring 34 causes the driveshaft 36 to emit less noise over the majority of the range depicted. In contrast, when there is no inertia ring 34 attached, sound emitted by the driveshaft 36 increases and decreases in an oscillating manner as the frequency increases. As the frequency of the shaft increases there are peaks 66 in the amount of sound emitted. These peaks 66 are most visible in the unmodified response 64 at approximately 1080, 1110 and 1150 Hz.

Weight is an important factor in the design of an automobile. While there is minimal difference in the noise emitted between the two pound inertia ring 34 response 68 and 9.4 pound inertia ring 34 response 70, weight reduction design preferences would favor the two pound 68 inertia ring 34 for use on a vehicle driveshaft 36.

While the best mode for carrying out the invention has been described in detail, those familiar with the art to which this invention relates will recognize various alternative designs and embodiments for practicing the invention as defined by the following claims.

What is claimed:

1. A combination of an inertial body and a shaft comprising:
an elongated hollow member having a vibration characteristic including a bending mode and a breathing mode, the bending mode vibration characteristic and the breathing mode vibration characteristic having closely coupled resonance frequencies; and
an inertia member of predetermined mass attached to the elongated hollow member proximate a bending mode vibration antinode to decouple the bending mode vibrational resonance frequency from the breathing mode vibrational resonance frequency.

2. The combination according to claim 1, wherein the elongated hollow member is a driveshaft.

3. The combination according to claim 1, wherein high frequency gear transmitted errors from either a transmission or an axle cause an expansion and contraction of the elongated hollow member in the breathing mode.

4. The combination according to claim 1, wherein high frequency gear transmitted errors from either a transmission or an axle cause an oscillation of the elongated hollow member in the bending mode.

5. The combination according to claim 1, wherein the inertia member is attached to the elongated hollow member proximate a bending mode vibration antinode nearest an end of the elongated hollow member.

6. The combination according to claim 1, wherein the inertia member is fixed to the elongated hollow member using a press fit.

7. The combination according to claim 1, wherein the inertia member includes two separate halves, the inertia member being affixed to the elongated hollow member by clamping the two halves to the elongated hollow member.

8. A driveshaft for torque transmission purposes especially for use in a drivetrain of a motor vehicle, the drive shaft comprising:
a shaft having first and second ends and a central region;
an inertia ring fixed at a bending mode antinode on the shaft, the inertia ring decoupling a closely coupled bending mode vibrational resonance frequency and breathing mode vibrational resonance frequency to reduce the amplitude of shaft vibrations whereby the amount of noise emitted by the driveshaft is reduced.

9. The driveshaft according to claim 8, wherein the inertia ring is fixed to the shaft at a bending mode antinode nearest a rear axle.

10. The driveshaft according to claim 8, wherein the inertia ring has an inner diameter and wherein an outer diameter of the shaft is greater than the inner diameter of the inertia ring so that the inertia ring may be press fit onto the shaft.

11. The driveshaft according to claim 8, wherein the inertia ring is securely fixed to the shaft and does not oscillate or vibrate independently from the driveshaft.

12. The driveshaft according to claim 8, wherein the inertia ring is rotationally symmetrical.

13. The driveshaft according to claim 8, wherein the weight of the inertia ring is determined by finite element analysis of the drivetrain.

14. The driveshaft according to claim 8, wherein the inertia ring is made of aluminum.

15. The driveshaft according to claim 8, wherein the inertia ring is made of steel.

16. The driveshaft according to claim 8, wherein the weight of the inertia ring is determined by testing.

17. A drivetrain for a vehicle having an engine, transmission, differential and driveshaft connection wherein the driveshaft connection comprises:
a shaft having first and second ends and a central region;
an inertia ring having an inner opening fixed at a specified point on the shaft to decouple the frequency at which bending mode vibrational resonance occurs from the frequency at which breathing mode vibrational resonance occurs to reduce the amplitude of driveshaft vibrations and to limit the amount of noise emitted by the driveshaft.

18. The drivetrain according to claim 17, wherein the inertia ring is fixed at an antinode.

19. The drivetrain according to claim 17, wherein an outer diameter of the shaft is greater than an inner diameter of the inertia ring so that the inertia ring may be press fit in place at a desired location corresponding to an antinode.

20. The drivetrain according to claim 17, wherein the inertia ring is securely fixed to the shaft and does not oscillate or vibrate independently from the driveshaft.
